(19) United States
(12) Patent Application Publication
(10) Pub. No.: US 2002/0172240 A1
(43) Pub. Date: Nov. 21, 2002

(54) Modulation current compensation of a laser for fixed extinction ratio using Ith and Ibias

(76) Inventor: Bongsin Kwark, Irvine, CA (US)

Correspondence Address: JONES VOLENTINE, P.L.L.C., SUITE 150, 12200 SUNRISE VALLEY DRIVE, RESTON, VA, 20191, US

(21) Appl. No.: 09/907,498

(22) Filed: Jul. 16, 2001

Related U.S. Application Data
(60) Provisional application No. 60/276,136, filed on Mar. 16, 2001.

(51) Int. Cl. H01S 3/10; H01S 3/00

(52) U.S. Cl. 372/26; 372/38.02

(57) ABSTRACT

According to an exemplary embodiment of the present invention, a method of controlling an optical device includes calculating a slope of a characteristic curve and adjusting a modulation current based on said slope.

According to another exemplary embodiment of the present invention, an apparatus for controlling an optical device includes a driver, which inputs a modulation current, and a controller which calculates the modulation current based on a slope of a characteristic curve.

### FIELD OF THE INVENTION

The invention relates generally to optical communications, and specifically to a method and apparatus for maintaining the extinction ratio and average optical output power of a laser device over time and temperature variations.

### BACKGROUND OF THE INVENTION

Digital fiber-optic communications have gained widespread acceptance for both telecommunication and data communication applications. Telecommunication systems typically operate over single mode fiber at distances from 10 kilometers to over 100 kilometers and employ lasers emitting at wavelengths of 1310 nm or 1500 nm. Data communication systems typically cover shorter distances of up to a few kilometers, often over multi-mode fiber. Data communication systems can employ laser devices as well, typically having emission wavelengths of 650 nm to 850 nm. As the data rates of the transmission in the telecommunication and data communication industries continue to increase, there are ever increasing demands placed on the various components of the optical communication system.

In modern optical communications, an optical carrier signal is often digitally modulated. This digital modulation results in a series of “high” (digital “one” bit) and “low” (digital “zero” bit) power outputs by the laser device. It is important to maintain respective optical output the power levels of the digital “high” and digital “low”. In particular, at the receiver end, the received optical signal is converted to an electrical signal. The digital “high” corresponds to a particular voltage level, while the digital “low” corresponds to another voltage level. If, for some reason, the optical power is not maintained at a suitable level such that the converted electrical signal is not above a particular threshold for a digital “high”, or the optical output power of a digital “low” is not sufficiently low that the electrical signal is below a particular threshold, errors in the signal transmission may result. These errors are ultimately manifest in unacceptable bit error ratios (BER).

As can be appreciated, it is useful to constantly monitor the output of an optical transmitter, such as an optical laser to ensure that the optical signal transmitted has output power levels for digital “highs” and “lows” that are at certain power levels. One measure of the output of a laser is known as the extinction ratio. The extinction ratio is a measure of the amplitude of the digital modulation on the optical carrier. The extinction ratio is defined as the average optical power of a digital logic one bit (high) divided by the average optical energy in a digital logic zero bit (low):

$$E = \frac{{P}_{1}}{{P}_{0}} \qquad ( 1 )$$

where E is the extinction ratio; P₁ is the average optical power in a logic one bit; and P₀ is the average optical power in a logic zero bit. Standards for communication systems such as the synchronous optical network (SONET) or SDH specify minimum extinction ratio requirements for laser transmitters. Typically, when a laser is digitally modulated for signal transmission, the extinction ratio of the modulated laser should be kept nearly constant for better transmission of the signal. Normally, there is a minimum extinction ratio requirement set by the standard, and it is important to maintain the extinction ratio of the digitally modulated laser in an optical transmission system at or above this minimum requirement. This ensures that the BER is maintained to the standard of the particular optical communication system in which the laser is deployed.

As is known, the extinction ratio may be impacted by a variety of influences in an optical communication system. Two influences are the affects of temperature and aging on a laser or other active device used for the optical signal transmission. The influences of temperature and aging on the output of the laser may be readily understood from the characteristic curves of a laser such as that shown in FIG. 1, which is a graph of the optical power versus laser current for a laser. Characteristic curve 101 is the optical output power versus laser current for a laser at a first temperature, prior to the impact of aging. Contrastingly, characteristic curve 102 is the optical power versus laser current of a laser device impacted by elevated temperature and/or aging.

Illustratively, a chosen extinction ratio (P₁/P₀) may be as shown in FIG. 1. For the laser operating along curve 101, output P₁ corresponds to a particular laser current 103; and optical output power P₀ corresponds to a particular laser current 104. However, as the laser ages and/or is subject to an increased temperature, it illustratively operates along characteristic curve 102. If the laser current levels are maintained at 103 for the optical power of a logic one bit, and at laser current level 104 for a logic zero bit, the output of the laser operating along characteristic curve 102 will be significantly reduced. Specifically, the output power for a logic one bit will be P₁′, and the output power for a logic zero bit will be P₀′, as is shown in FIG. 1. As can be readily appreciated, the extinction ratio

$$( \frac{{P}_{1}^{′}}{{P}_{0}^{′}} )$$

will be reduced to unacceptable levels. Accordingly, the bit error ratio will be unacceptably low, and transmission of voice and data may be severely impacted.

Moreover, it is often useful to maintain the average power of the optical signal at a predetermined level. Illustratively, this average power is the average of the optical power of a logic one bit and the optical power of a logic zero bit. For example, the average optical power for a device operating along characteristic curve 101 is at a predetermined value, Pₐᵥ. This illustrative predetermined value may be one set by a particular standard. As the effects of time and aging impact a device, the average power may also be significantly impacted. For example, the average of P₁′ and P₀′ is Pₐᵥ′, which may be unacceptably low.

One conventional method of controlling an output of a laser is to incorporate a thermoelectric cooler into a laser package so as to keep the laser at a constant temperature. As such, the laser will operate along a particular characteristic curve. Accordingly, the extinction ratio can be maintained at a constant level. However, there are certain disadvantages to this approach. For example, thermoelectric coolers tend to increase the cost of the device; increase the size of laser package; and decrease the reliability of the laser, since any failure of the thermoelectric cooler or its circuitry may result in the application of an inappropriate bias current as the temperature of the laser varies. Moreover, thermoelectric coolers may be difficult to implement in a variety of environments. Finally, the thermoelectric cooler does not mitigate the effects of aging on the device, which can equally impact the extinction ratio and average output power of the device over time.

Accordingly, while conventional techniques to maintain the extinction ratio have had some success, there are shortcomings associated therewith, some of which are described above.

What is needed, therefore, is a technique which substantially maintains the extinction ratio of a laser by correcting for both temperature induced changes as well as age induced changes in the slope of a laser device that overcomes the shortcomings of the conventional techniques described above.

### SUMMARY OF THE INVENTION

According to an exemplary embodiment of the present invention, a method of controlling an optical device includes calculating a slope of a characteristic curve and adjusting a modulation current based on said slope.

According to another exemplary embodiment of the present invention, an apparatus for controlling an optical device includes a driver, which inputs a modulation current, and a controller which calculates the modulation current based on a slope of a characteristic curve.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a graphical representation of optical power versus laser current showing the effects of temperature and/or aging on a laser.

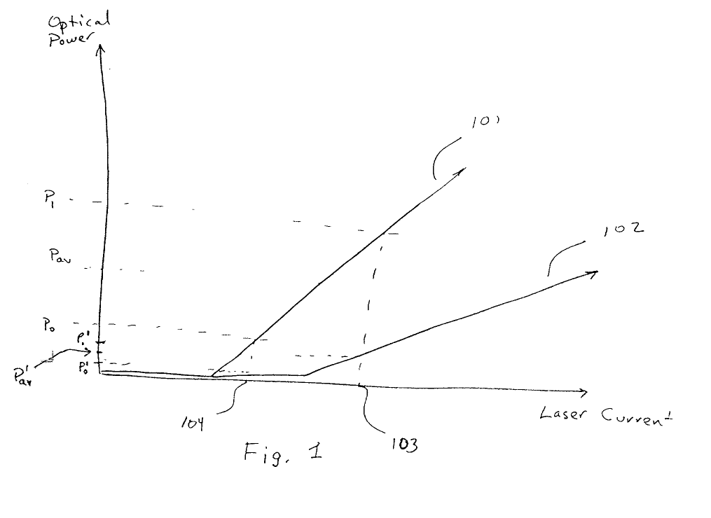

FIG. 2 is a graphical representation of optical power versus laser current showing the change in slope due to temperature and aging effects, as well as the extinction ratio and average optical output power, in accordance with an illustrative embodiment of the present invention.

FIG. 3 is a functional block diagram of a monitor, laser-driver feedback loop in accordance with an illustrative embodiment of the present invention.

FIG. 4 is a flow-chart of an illustrative method for determining the modulation and bias currents in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for maintaining the extinction ratio and average output power of a digital optical signal from an optical emitter over temperature and/or time. According to an illustrative embodiment of the present invention, the modulation current required to maintain a desired extinction ratio is calculated from the slope of the particular characteristic curve of the laser over which the laser is operating. Adjustments in the modulation current may be readily effected through the illustrative method of the present disclosure to maintain the extinction ratio as is desirable. According to an illustrative embodiment of the present invention, the modulation current is calculated using the threshold current and the bias current.

The threshold current may be calculated or measured. The bias current may be determined through an illustrative method described in further detail herein. Independently, a required change in the bias current necessary to maintain the average output power (Pₐᵥ) may be determined. According to the above exemplary embodiment of the present invention, the extinction ratio and average output optical power of a laser may be maintained at substantially constant levels over a wide temperature range and/or over the lifetime of a device.

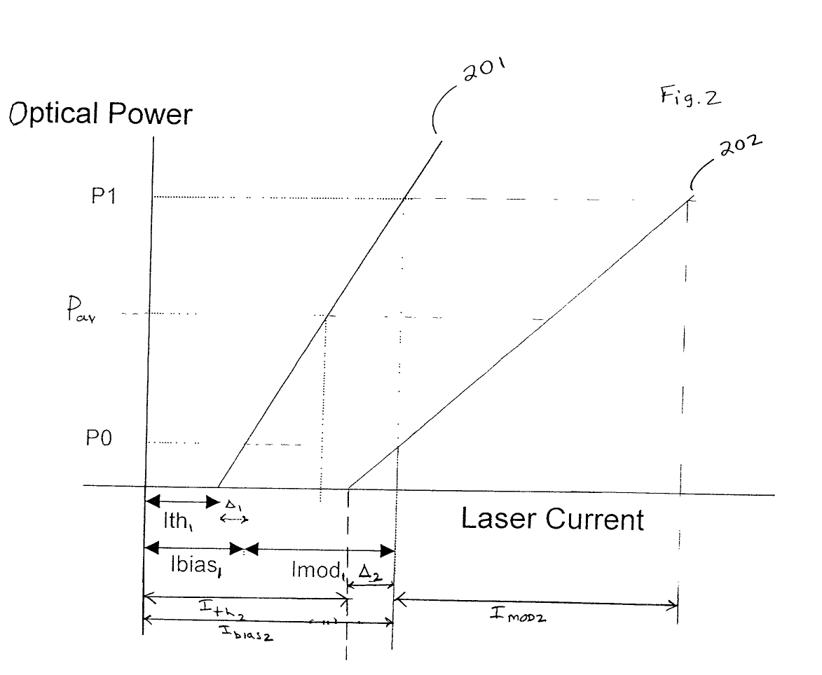

Turning to FIG. 2, a graph of output optical power versus laser current for a typical laser is shown. A first characteristic curve 201 is the operational characteristic of a laser device that may have been impacted by the affects of temperature and/or aging. A second characteristic curve 202 is the operational characteristic of the same laser device, which may have been further impacted by the effects of temperature and/or aging. In accordance with an exemplary embodiment of the present invention, the slope of characteristic curve 201, S₁, may be used to calculate the modulation current required to achieve the desired extinction ratio for a laser operating along this characteristic curve. Similarly, the slope of characteristic curve 202, S₂, may be used to calculate the required modulation current for a laser operating along this characteristic curve.

As is known, the threshold current (e.g., Iₜₕ₁, for a laser operating along characteristic curve 201) is the minimum current at which the laser turns “on.” Moreover, the laser is typically biased at a bias current (e.g. I_{bias1}, for a laser operating along characteristic curve 201) that is above the threshold current level of the laser in order to reduce relaxation oscillation. Finally, the laser operates substantially linearly in the operational range shown.

The modulation current of the laser operating along characteristic curve 201, I_{mod1}, results in the operation of the laser between a required output optical power level for a digital one bit (P₁) and the required output optical power for a digital zero bit (P₀). As mentioned previously, the ratio of these two powers defines the extinction ratio:

$$E = \frac{{P}_{1}}{{P}_{0}} \qquad ( 2 )$$

It can also be shown that the slope of characteristic curve 201 is:

$${S}_{1} = \frac{{P}_{1}}{{I}_{mod1} + ( {I}_{bias} - {I}_{th1} )} \qquad ( 3 )$$

Moreover, it can be shown that the slope of characteristic curve 201 is:

$${S}_{1} = \frac{{P}_{0}}{( {I}_{bias1} - {I}_{th1} )} \qquad ( 4 )$$

and, accordingly

Equating equations (3) and (4) yields:

$$\frac{{P}_{1}}{{P}_{0}} = \frac{{I}_{mod1} + ( {I}_{bias1} - {I}_{th1} )}{( {I}_{bias1} - {I}_{th} )} = E \qquad ( 5 )$$

where I_{mod1}, I_{bias1} and Iₜₕ₁ are the modulation current, bias current, and threshold current, respectively, of a laser device operating along characteristic curve 201.

As mentioned above, it is useful to maintain the extinction ratio of a laser over temperature and/or time. This may be effected in accordance with an exemplary embodiment of the present invention by determining the required modulation current, I_{mod1}, necessary to maintain the desired extinction ratio from the slope of characteristic curve 201. As mentioned previously, it also useful to maintain the average output power, Pₐᵥ. This may be accomplished independently using an automated power control (APC) to adjust the bias, I_{bias1}, to maintain the average output power, Pₐᵥ, that is desired.

The required modulation current, I_{mod1}, may be ascertained through straightforward manipulation of eqn. (5):

$$\begin{matrix}{I}_{mod1} = ( {I}_{bias1} - {I}_{th1} ) ( E - 1 ) \\ = ( {Δ}_{1} ) ( E - 1 )\end{matrix} , \qquad ( 6 )$$

where Δ₁ is the differential between the bias current, I_{bias1} and the threshold current, Iₜₕ₁, and is shown in FIG. 2.

Clearly, the desired extinction ratio, E, is known, and the threshold current, Iₜₕ₁, may be ascertained by a variety of techniques. Illustratively, the threshold current, Iₜₕ₁, may be measured. Alternatively, the threshold current may be determined using historical statistical data of the laser device. In particular, if the affect of aging on a laser device is insignificant, the threshold current may be measured over temperature in a standard testing procedure. These data may be stored in a look-up table and the data would be retrieved in a deployed system implementing the illustrative methods of the present invention described herein.

Additionally, the threshold current may be estimated over a wide range of operating temperatures and time (aging). To this end, the threshold current tends to vary exponentially over time and/or temperature. Illustratively, the threshold current, Iₜₕ₁, can be estimated through a rather straightforward calculation of an exponential function, such as:

Iₜₕ₁(T)=A+Be^{(T/C)} (7)

where T is the temperature, and A, B, and C are constants which can be determined from statistical data of the laser device.

Once the threshold current has been determined, the required bias current, I_{bias1}, must be determined in order to finally calculate the modulation current, I_{mod1}, according to eqn. (5) above. Illustratively, the bias current, I_{bias1}, may be determined using a measurement method incorporating a control circuit. As mentioned above, in most cases, automatic power control (APC) is incorporated concurrently with modulation current control. This APC loop usually monitors the laser back facet output with a monitor photodetector (e.g. a PIN photodetector) and keeps the monitor photodetector current substantially constant by adjusting a control port of the bias current supply circuit. Thereby, the actual bias current can be easily monitored using a current mirror technique, a series resistance, or other technique readily known to one having ordinary skill in the art. Once the bias current is known, the required modulation current may be determined.

As the performance of laser device is impacted by temperature and/or aging, the slope of the characteristic curve tends to decrease, and the required threshold current to turn the device on tends to increase. For example, after the affects of temperature and/or aging have impacted the laser device, the same laser which previously operated along characteristic curve 201, may operate along characteristic curve 202.

Accordingly, it may be necessary to make the required adjustments in the modulation current and bias current, I_{mod2} and I_{bias2}, respectively, to ensure that the desired extinction ratio, E, and average output optical power, Pₐᵥ, are maintained. Again, in accordance with an illustrative embodiment, the slope of characteristic curve 202, S₁, may be used to determine the required modulation current to maintain a desired extinction ratio.

By straightforward analysis identical to that used to determine I_{mod1} for the characteristic curve 201, the required modulation current, I_{mod2}, for characteristic curve 202 is found to be:

$$\begin{matrix}{I}_{mod2} = ( {I}_{bias2} - {I}_{th2} ) ( E - 1 ) \\ = ( {Δ}_{2} ) ( E - 1 )\end{matrix} \qquad ( 8 )$$

where I_{bias2}, Iₜₕ₂, and Δ₂ are the bias current, threshold current and differential of the bias and threshold currents, respectively.

It is noted the exemplary method described above is illustratively applied to a laser, such as a semiconductor laser. Of course, this is not intended to be limiting, but rather illustrative of the invention. Namely, the illustrative method of the present invention may be applied to other devices which are impacted by temperature and/or aging affects. Such devices will be within the purview of one having ordinary skill in the art.

As can be appreciated, the illustrative method for maintaining the extinction ratio and average output power may be effected iteratively and may be incorporated into a feedback control circuit for the laser device. According to illustrative embodiments described presently, a feedback control circuit and an iterative method enable the adjustment of the bias and modulation currents to maintain the extinction ratio and average output optical power, E and Pₐᵥ, respectively, at desired levels. Specifically, if a device operating along characteristic curve 201 experiences a shift in its operational characteristic to characteristic curve 202 due to the effects of aging and/or temperature, the adjustment in the modulation current and bias current to maintain the extinction ratio and average output optical power may be readily effected according to the illustrative method and apparatus of the present invention described herein.

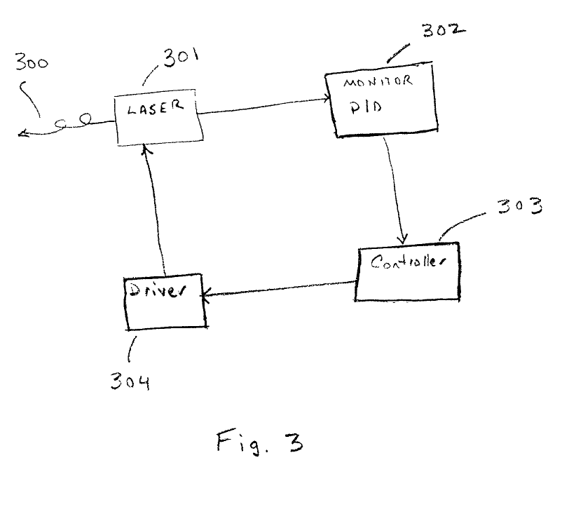

FIG. 3 is a functional block diagram of a feedback control circuit according to an illustrative embodiment of the present invention. This feedback control circuit may adjust the modulation current and (D.C.) bias current in accordance with illustrative embodiments of the present invention to maintain the extinction ratio and average output power at substantially constant levels. To this end, laser 301 emits a signal to an optical fiber 300 which is connected to an optical communication system (not shown). A portion of the light from the laser 301 is impingent a monitor photodetector 302. Illustratively, if the laser is a semiconductor laser such as a laser diode, the rear facet of the laser emits a portion of the light that is received by the monitor photodetector 302. Alternatively, an optical tap may be used to divert a small portion of the laser output to the monitor photodetector.

The monitor photodetector 302 transforms the optical signal received into an electrical signal. This electrical signal is input to a controller 303, which performs the requisite calculations in accordance with illustrative embodiments of the present invention to substantially maintain the extinction ratio, E and average output optical power, Pₐᵥ, at constant levels. The controller 303 then issues controller commands to the driver 304. The controller commands may include a modulation current control signal and a bias current control signal. The driver 304 includes an automatic power controller (APC), which controls the bias current of the laser. The driver 304 also includes a modulation current controller that controls the modulation current to the laser. Based on the controller commands from the controller 303, the driver 304 changes the D.C. bias current and modulation current, as needed, to maintain the extinction ratio and the average power of the laser 301, each at prescribed levels of operation.

Illustratively, the controller 303 receives input from the monitor photodetector 302 which is representative of the output of the laser 301. The controller 303 may include a look-up table to determine the threshold current for over a temperature range if the effect of aging is insignificant. Alternatively, the controller 303 may calculate the threshold current for a wide range of temperature values and over an anticipated lifespan of a particular device using an exponential function such as that referenced above. Moreover, through the input of the monitor photodetector, a measurement method for the bias current (such as that described above) may implemented at the controller 303 to determine the required bias current to maintain the desired average output optical power. Once the threshold current and bias current have been calculated at the controller 303, the required modulation current may be readily calculated using, for example, eqn. (8) above. Thereafter, the controller 303 inputs the required bias and modulation currents to the driver 304, and the driver 304 makes any necessary adjustments to the laser 301 to maintain operation at desired levels.

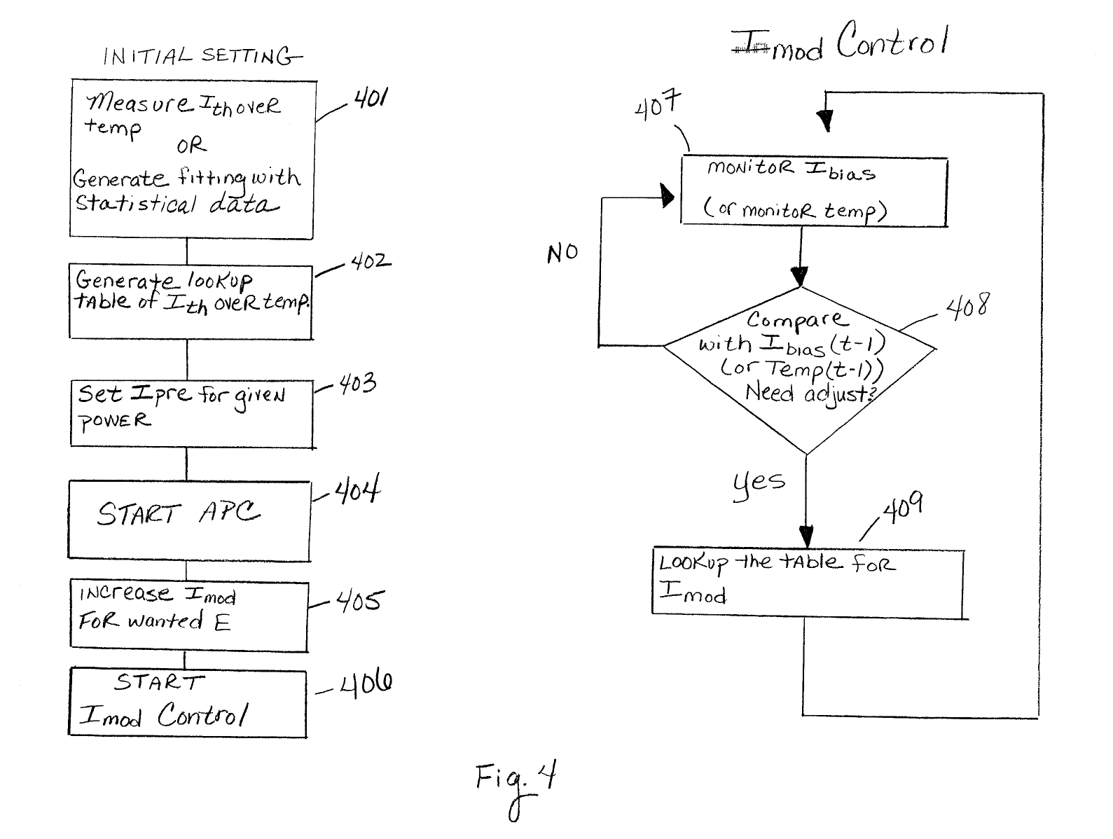

Turning to FIG. 4, a flow chart of an illustrative method of the present invention for determining the required modulation current and bias current is shown. The illustrative method shown in FIG. 4 may be used in conjunction with a feedback control circuit such as that of the illustrative embodiment shown in FIG. 3.

The illustrative method shown in FIG. 4 includes an initial setting technique presently described. As shown as 401, the threshold current of a laser device may be measured by standard technique. Alternatively, the threshold current may be estimated over a wide range of temperatures, and over time using an exponential function such as that referenced above. As mentioned previously, the measurement of the threshold current is useful when the effect of aging is negligible. Alternatively, the estimation of the threshold current may be useful when the effects of aging are not insignificant.

At 402, a look-up table of the threshold current over temperature may be generated. Next, at 403, the initial bias current, Iₚᵣₑ, is set for a particular output power level, which is application dependent. In the present exemplary embodiment, the initial bias current setting is given by,

$${I}_{pre} = {I}_{bias1} + \frac{{I}_{mod1}}{2} \qquad ( 9 )$$

where I_{bias1} and I_{mod1} are the bias current and modulation current levels, respectively, of a laser operating along characteristic curve 201 of FIG. 2. It is noted that Iₚᵣₑ is set as described because at this point in the illustrative method, no modulation current is applied to the laser, and the laser is operating in continuous wave (CW) mode. As such, the average optical output power may be set with the bias current (D.C.) alone.

Next, at 404, the APC is started. As described previously, the APC is useful in independently setting the bias current of the laser device so that the device operates at a particular average optical output power level. Next, at 405, the modulation current, I_{mod}, is increased for a particular desired extinction ratio, E. For example, the modulation current may be increased to I_{mod1} for a laser operating along characteristic curve 201 of FIG. 2. As the modulation current is increased, the (D.C.) bias current is decreased. For example, as I_{mod} is increased to I_{mod1} for a laser operating along characteristic curve 201 of FIG. 2, the bias current is set at I_{bias1}.

With the initialization sequence of 401-405 completed, the modulation current control method (I_{mod} Control) in accordance with the present exemplary embodiment is commenced at 406. The particular details of the I_{mod} control of 406 are shown in FIG. 4 at 407-409. Illustratively, the modulation current loop includes monitoring the bias current and adjusting the modulation current I_{mod} by using a look-up table of stored data. At 407, the bias current, I_{bias}, is monitored at time t. This is compared with bias current level at time t=t−1. If the change in the bias current is within a range determined by an allowable extinction ratio tolerance, then 407 is repeated. If the extinction ratio is outside the allowable tolerance, the required modulation current at a particular temperature may be obtained from a look-up table and the modulation current may then be adjusted. At this point, the sequence begins again at 407.

A few points are noted. First, the look-up table for I_{mod} may be assembled for temperature and/or time values using the illustrative method of calculating I_{mod} as described above. Moreover, the illustrative I_{mod} Control method of FIG. 4 may be used in conjunction with a feedback control circuit such as that of the exemplary embodiment of FIG. 3. In this case, the look-up table would be resident in the controller 303, and commands to effect changes in I_{mod} would be sent from the controller 303 to the driver 304, which would effect such changes. Moreover, as shown at 408, the iterative comparison may be of temperature in the case when aging affects are negligible, and the look-up table may be used to determine the needed I_{mod} therefrom. Of course, it is within the purview of the present invention that adjustments to I_{mod} may be made using device age-data, as well. Finally, the iterative method of the illustrative embodiment of FIG. 4 may be repeated continually, at an interval of approximately a few milliseconds to approximately a few seconds.

It is noted that the control apparatus and method described are illustratively applied to a laser, such as a semiconductor laser. Of course, this is not intended to be limiting, but rather illustrative of the invention. Namely, the control apparatus and method of the present invention may be applied to other devices which are impacted by temperature and/or aging affects. Such devices will be within the purview of one having ordinary skill in the art.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

I claim:

1. A method of controlling an optical device, the method comprising:
calculating a slope of a characteristic curve of the optical device; and
calculating a modulation current from said slope.

2. A method as recited in claim 1, where said modulation current is adjusted if an allowable tolerance of an extinction ratio is exceeded.

3. A method as recited in claim 1, wherein said slope is given by
$$S = \frac{{P}_{1}}{( {I}_{mod} + ( {I}_{bias} - {I}_{th} )} = \frac{{P}_{0}}{( {I}_{bias} - {I}_{th} )}$$
where P₀ is an optical output power of logic zero bit, P₁ is an optical output power of a logic one bit, I_{mod} is a modulation current, I_{bias} is a bias current, and Iₜₕ is a threshold current.

4. A method a recited in claim 1, wherein said modulation current is given by
_{mod}=(_{bias}−Iₜₕ)(E−1)
where I_{bias} is a bias current, Iₜₕ is a threshold current, and E is an extinction ratio.

5. A method as recited in claim 1, wherein said calculating said modulation current further comprises determining a threshold current, Iₜₕ, and bias current, I_{bias}.

6. A method as recited in claim 5, wherein said threshold current is estimated.

7. A method as recited in claim 5, wherein said threshold current is estimated using
Iₜₕ₁(T)=A+Be^{(T/C)},
where A, B and C are constants, and T is a temperature.

8. A method as recited in claim 5, wherein said threshold current is measured over temperature.

9. A method as recited in claim 5, wherein the method further comprises retrieving a desired threshold current value from a look-up table.

10. A method as recited in claim 1, wherein the method further comprises adjusting a bias current to the optical device.

11. A method as recited in claim 1, wherein the method further comprises adjusting said modulation current to the laser device based on said calculation of said modulation current to substantially maintain an extinction ratio at a particular value.

12. A method as recited in claim 10, wherein said adjusting said bias current substantially maintains an average output optical power.

13. A method as recited in claim 1, wherein the method is continually repeated.

14. An apparatus for controlling an optical device, comprising:
a driver which inputs a modulation current to the optical device; and
a controller which calculates said modulation current based on a slope of a characteristic curve.

15. An apparatus as recited in claim 14, wherein said inputs from said driver is based on a command from said controller.

16. An apparatus as recited in claim 14, wherein said controller continually performs said calculation on a regular temporal interval.

17. An apparatus as recited in claim 15, wherein said controller further includes a look-up table which stores threshold current data.

18. An apparatus as recited in claim 1, wherein a threshold current and a modulation current are used by said controller to calculate said modulation current.

19. An apparatus as recited in claim 18, wherein said threshold current is estimated by said controller.

20. An apparatus as recited in claim 18, wherein said threshold current and said bias current are measured.

21. An apparatus as recited in claim 18, wherein a plurality of threshold current values are stored in a look-up table in said controller.

22. An apparatus as recited in claim 14, wherein said driver further includes an automated power control (APC).

23. An apparatus as recited in claim 22, wherein said APC maintains an average optical output power, Pₐᵥ, at a substantially constant level.

24. An apparatus as recited in claim 23, wherein said APC adjusts a bias current to the optical device.

25. An apparatus as recited in claim 22, wherein said APC is used to calculate a bias current which is used to calculate said slope.

26. An apparatus as recited in claim 25, wherein a current mirror technique is used to calculate said bias current.

27. An apparatus as recited in claim 14, wherein the optical device is a laser.
